(19) United States
(12) Patent Application Publication
(10) Pub. No.: US 2023/0284828 A1
(43) Pub. Date: Sep. 14, 2023

(54) ELECTRIC TACO GRIDDLE

(71) Applicant: Xavier G. Gonzalez, Mesa, AZ (US)

(72) Inventor: Xavier G. Gonzalez, Mesa, AZ (US)

(21) Appl. No.: 18/197,969

(22) Filed: May 16, 2023

Related U.S. Application Data
(63) Continuation-in-part of application No. 17/491,635, filed on Oct. 1, 2021.

(51) Int. Cl. A47J 37/06

(52) U.S. Cl. CPC A47J 37/0611

(57) ABSTRACT

A food heating appliance comprises a grill member with an upper food contact surface having an articulated surface having upwardly-open cooking troughs for receiving food items such as tacos. The trough sidewalls are tapered and narrow upwardly. Each trough is defined by spaced-apart cooking sidewalls connected at a lower surface portion, with a horizontal heating element connected to the lower surface portions, A plurality of heat sink facilities are registered with each with its trough. Each heat sink facility defines a channel that closely receives a portion of the heating element assembly. Each trough is defined between an inboard cooking sidewall and an outboard cooking sidewall, with the inboard sidewalls being proximate each other and being thicker that than the outboard cooking sidewalls. The grill is a unitary casting with a peripheral rim encompassing the heating element assembly and free of undercuts and of negative draft angles.

### CROSS-REFERENCE TO RELATED APPLICATIONS

This is a continuation-in-part of U.S. patent application Ser. No. 17/491,635 filed on Oct. 1, 2021, entitled “ELECTRIC TACO GRILLER.”

### FIELD OF THE INVENTION

The present invention relates to small appliances for cooking or heating foods, especially tacos or foods having a similar cross sectional shape as a taco.

### BACKGROUND AND SUMMARY

Cooking tacos according to traditional methods typically involves pan-frying corn or wheat dough discs in oil, turning them over so both sides cook evenly in the oil, and then curling them up at just the right moment to form crunchy, semi-circular shells having spaced apart lobes. While partially cooked, the upper lobe must be supported at a desired spacing from the lower lobe, and cooking proceeds unevenly with the lower lobe immersed in oil while the upper lobe remains in air above the oil. The taco shell must be flipped over in the oil a number of times until both lobes are cooked evenly and completely. This process is time-consuming and it is difficult for home cooks or other non-professionals to produce pleasingly uniform results wherein a set of fried taco shells contain reasonably similar volumes of for food fillings.

Also, foods made by deep frying dough in oil are high in calories. Taco shells made by traditional methods immerse the dough in oil for several minutes at a time and thus they absorb a lot of oil. People minding their calorie intake would prefer tacos made by other methods than immersing the taco shell in fry oil.

There is also a desire for convenience in food preparation, so that processes requiring multiple steps using multiple cooking tools can be consolidated to fewer steps and tools, or a single step or tool.

The above disadvantages are addressed by providing a food heating appliance that comprises a grill member with an upper food contact surface having an articulated surface having upwardly-open cooking troughs for receiving food items such as tacos. The trough sidewalls are tapered and narrow upwardly. Each trough is defined by spaced-apart cooking sidewalls connected at a lower surface portion, with a horizontal heating element connected to the lower surface portions, A plurality of heat sink facilities are registered with each with its trough. Each heat sink facility defines a channel that closely receives a portion of the heating element assembly. Each trough is defined between an inboard cooking sidewall and an outboard cooking sidewall, with the inboard sidewalls being proximate each other and being thicker than the outboard cooking sidewalls. The grill is a unitary casting with a peripheral rim encompassing the heating element assembly and free of undercuts and of negative draft angles.

### BRIEF DESCRIPTION OF THE DRAWINGS

FIG. 1 shows an oblique, top front left view of an electric taco griddle in accordance with the invention and also showing two taco formers, one seated within a cooking trough of a grill casting and the other elevated out of the trough for inspection.

FIG. 2 shows an oblique, bottom front left view of the electric taco griddle of FIG. 1 showing that the underside of the grill casting defines a channel configured to closely receive the elongated portions and the serpentine portions of a heating element assembly.

FIG. 3 shows an exploded view of various components of the electric taco griddle of FIG. 1, but omitting common threaded hardware such as machine screws and sheet metal screws.

FIG. 4 shows a front view of the electric taco griddle of FIG. 1 with one of two taco formers seated within a cooking trough of the grill casting and the other elevated out of the trough for inspection, and defines section lines A-A for the cross section view of FIG. 5a and B-B for the cross section view of FIG. 5b.

FIG. 5a shows a cross section view of the electric taco griddle of FIG. 1 taken at section line A-A of FIG. 4.

FIG. 5b shows a cross section view of the electric taco griddle of FIG. 1 taken at section line B-B of FIG. 4.

FIG. 6a shows an oblique, top rear left view of the grill casting of the electric taco griddle of FIG. 1.

FIG. 6b shows an oblique, bottom rear left view of the grill casting of the electric taco griddle of FIG. 1 and its channel features configured to closely receive elongated and serpentine portions of the heating element assembly.

### DETAILED DESCRIPTION OF A PREFERRED EMBODIMENT

The invention is an electric taco griddle which in a typical embodiment cooks two raw tortillas at once to make taco shells in paired troughs of a “W” shaped grilling surface, and may be used to prepare tacos with fillings heated by the appliance. Compared to traditional deep frying or pan frying methods, the griddle allows taco shells to be toasted to crispy firmness while using little to no cooking oils or grease. Reducing oil content of foods reduces their calorie content, so tacos produced using the present invention may be healthier for eating than traditional high-calorie tacos.

The grill surface is easily cleanable and may include stick-resistant coatings such as Teflon® (polytetrafluoroethylene.) Compared to pan frying methods or other methods which require time to heat a volume of oil up to cooking temperature, the electrically heated grilling surface achieves desired cooking temperatures within a few minutes and eliminates extra time and logistics spent to cool down and re-store used cooking oil after cooking is finished. The appliance is conveniently sized for home use.

The invention also includes one or more taco formers which are removable tools that retain and form an uncooked tortilla into the typical clamshell shape. The formers are thin, slotted membranes that do not extract substantial amounts of heat from the grill or the tortilla, so that the former does not interfere with cooking times or set temperatures. The taco former may include non-stick coatings and is easy to clean because the slots allow generous passage of washing and rinsing water throughout this component.

After gathering or making quantities of edible components such as uncooked tortillas and desired fillings, typical taco production using the inventive electric taco griddle includes steps of placing a tortilla into an available heated cooking trough so that it begins to cook while conforming to the contour of the trough. A typical tortilla is roughly circular and the trough will support two roughly semicircular lobes with one lobe on each of the sloped sides of the trough. A taco former is then inserted into the gap between the two lobes of the tortilla. The former holds the tortilla in the shape of a taco while it cooks and becomes firmer, toasted and crispier and able to retain its own shape. The cooked taco may then be removed by sliding it out an end of a trough and filled outside of the griddle, or the taco former may be removed and fillings may be deposited into the taco and cooked while in the griddle.

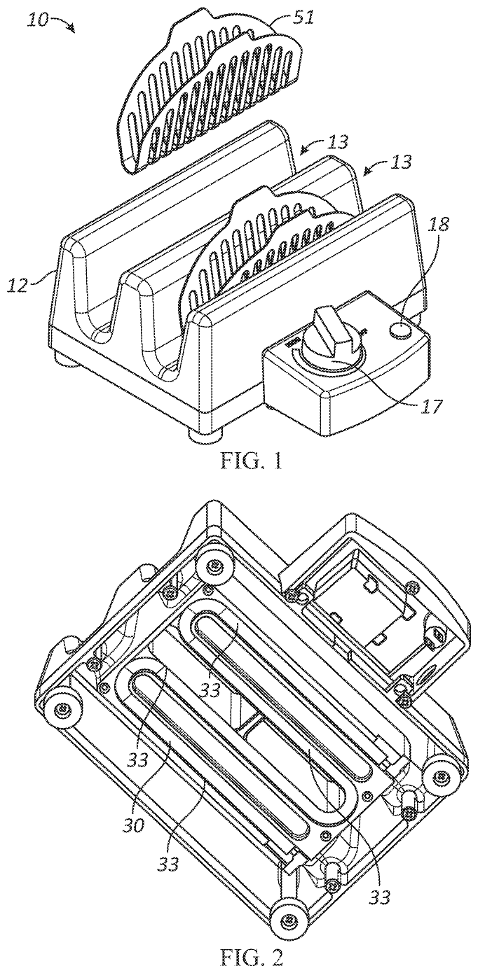

FIG. 1 shows an oblique, top front left view of an electric taco griddle [10] in accordance with the invention and also showing two taco formers [51,] one seated within a cooking trough [13] of a grill casting and the other elevated out of the trough for inspection. The griddle includes a grill casting [12] which is a single, unitary component having a lower rim and a plurality of corrugations that form a series of parallel cooking troughs. Uncooked tortillas are deposited in the troughs and the taco formers are inserted into the tortilla to hold the tortilla membrane portions in contact with the heated cooking surfaces of the griddle. The griddle as an appliance includes a console with a control knob [17] which in preferable embodiments actuates a thermostat control but may also control a mechanical timer. The console also includes an indicator light [18] which preferably indicates when electrical power is being applied to internal heating elements but in alternative embodiments may indicate available power (i.e, unit is plugged in) an “unsafe to touch” condition while the cooking surfaces are hot, a “ready for cooking” condition wherein heating elements or cooking surfaces have achieved an operational temperature, an elapsed time for cooking, or an overheat condition.

FIG. 2 shows an oblique, bottom front left view of the electric taco griddle of FIG. 1 showing that the underside of the grill casting defines a channel configured to closely receive the elongated portions [33] and the reversing curve portions of a heating element assembly [30.] The heating element assembly is connected to the lower surface portions of the casting proximal to the bottoms of the cooking troughs. The heating element assembly is connected directly to the lower surface portion of the grill casting so that it remains in physical contact with the grill casting for heat transfer from the heating element into the mass of the casting. The grill has a peripheral rim encompassing the heating element assembly, and on the underside, a plurality of rubber feet reside within and near the periphery of the “footprint” of the casting. Other soft and elastomeric materials may be used for the feet including but not limited to natural and synthetic rubber, plastics, and materials having a Shore A durometer between about 20 A and about 70 A.

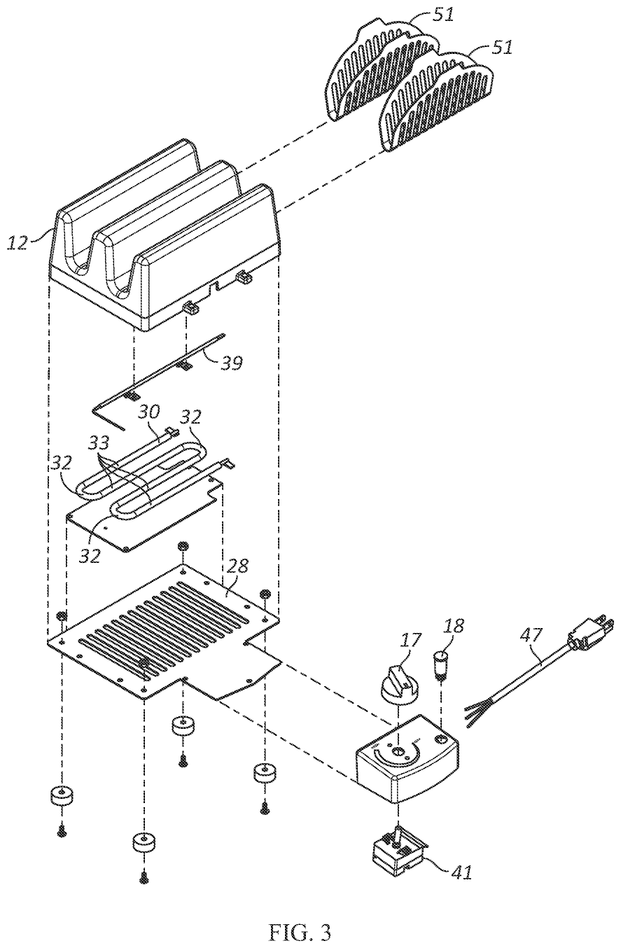

FIG. 3 shows an exploded view of various components of the electric taco griddle of FIG. 1, but omitting common threaded hardware such as machine screws and sheet metal screws. Taco formers [51] are provided with the appliance for retaining uncooked tortilla into taco shapes until the cooking process makes them sufficiently rigid to retain the desired shape while unsupported. The grill casting [12] includes a lower rim which encompasses most of the other components of the appliance. A thermal sensor [39] is affixed to the underside of the casting for monitoring and controlling cooking temperature. A planar serpentine heating element [30] includes elongated straight sections [33] connected at alternating ends by reversing bend portions [32] to form a single continuous contour. A heat shield resides beneath the heating element to protect the surface where the appliance is used, and to reflect heat back to the casting where it is useful, thus reducing energy waste.

A louvered base plate [28] is secured to the underside of the grill casting by fasteners which pass though the feet or footpads at the underside corners of the appliance. The base plate includes a tongue extending beyond the “footprint” or underside perimeter rim of the grill casting. This tongue supports a console with an indicator light [18] and a knob [17] connected to the shaft of a temperature controller [41.] Electric power is delivered by a power cord [47.] The base plate includes a planar bottom panel attached to the grill to enclose the heating element assembly.

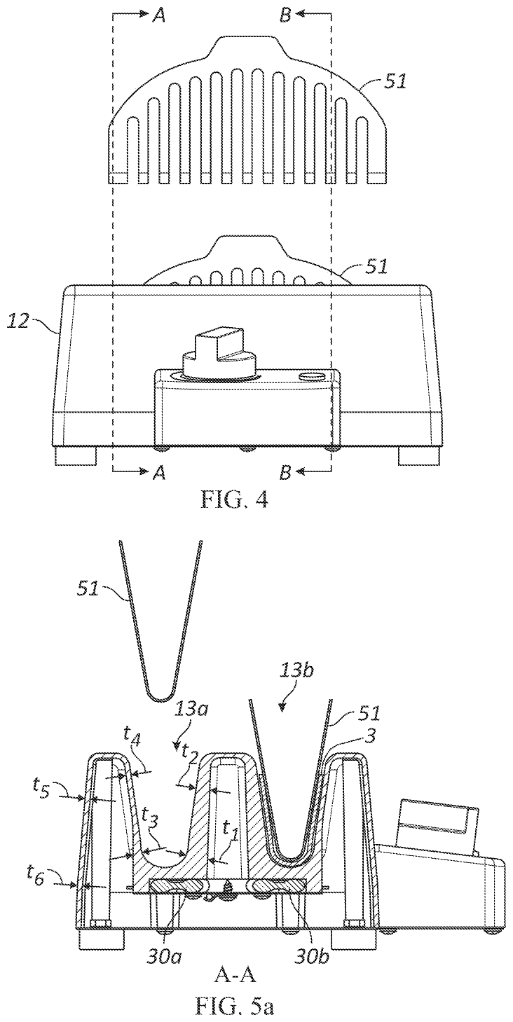

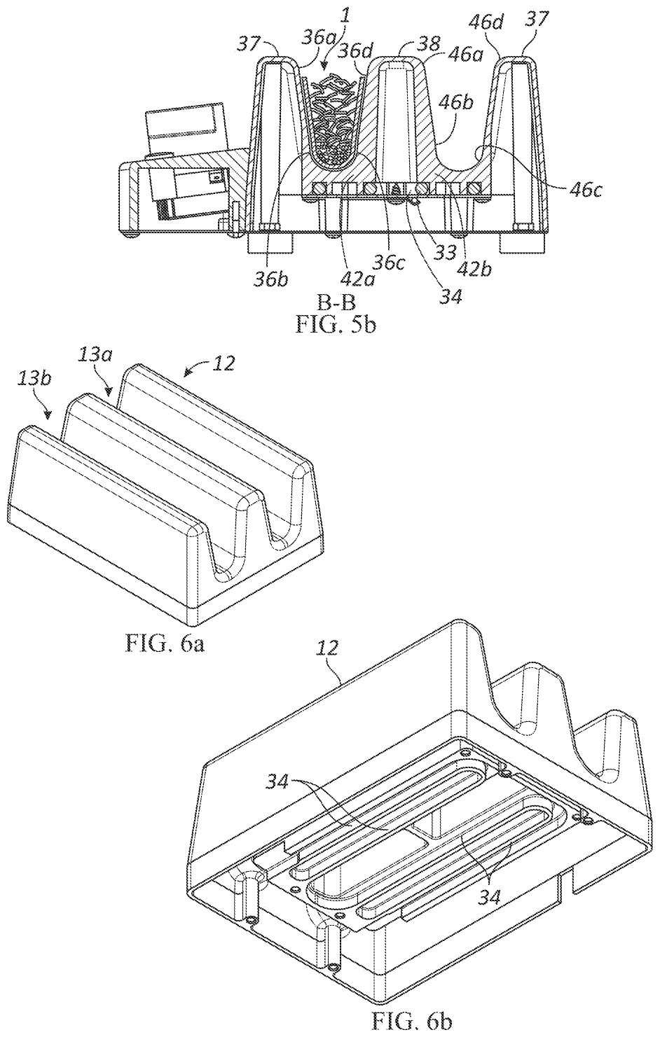

FIG. 4 shows a front view of the electric taco griddle of FIG. 1 with one of two taco formers [51] seated within a cooking trough of the grill casting [12] and the other elevated out of the trough for inspection, and defines section lines A-A for the cross section view of FIG. 5a and B-B for the cross section view of FIG. 5b. The heating elements are not visible in this view because the lower rim extends downward to a level below the troughs.

FIG. 5a shows a cross section view of the electric taco griddle of FIG. 1 taken at section line A-A of FIG. 4. In this view the casting includes two cooking troughs [13a] and [13b.] The heating element is a horizontal element attached to the underside of the grill casting below the troughs. The lower rims of the grill casting by the console and its control knob and proximal to the rubber feet of the appliance extend to a level below the troughs. Each trough is defined by spaced-apart cooking sidewalls connected at a lower surface portion and a heating element assembly connected to the lower surface portions.

Near the bottom of each of the cooking troughs, the wall thicknesses of the casting expand to form a heat retaining mass which in this specification is called a “heat sink.” Unlike a typical heat sink in an electronics enclosure which is designed to conduct heat way from a heat generating component and limit its operating temperature, a “heat sink” in this specification is a thermal mass or a heat reservoir. Each trough includes a heat sink proximal to its bottom cooking area. The thermal mass of the heat sink is a facility that delivers a consistent flow of heat from the reservoir mass to the items being cooked. The even flow of heat cooks the tortillas evenly and efficiently.

On the underside of the grill casting, each of the heat sink facilities defines a channel configured to closely receive an elongated portion of the heating element assembly. Trough [13a] has elongated portions of a heating element [30a] proximal to it, and trough [13b] has elongated portions of a heating element [30b] proximal to it. The taco former in trough [13b] is shown forcing a tortilla [3] to conform to the sloping sides and rounded bottom of the trough. When the cooking is complete, the crispy taco may be removed and cooled, or fillings may be added for continued cooking in the trough.

The heat sink facilities are the thickened portions of the grill casting proximate to the bottoms of the troughs. In this embodiment shown, the wall thicknesses of the sidewalls of troughs of the grill casting closer to the midplane of the casting are thicker than their opposite sidewalls. The sidewalls are tapered and narrow upwardly. The outer sidewalls of the casting have upper portions that are connected to upper portions of the cooking sidewalls, and the outer sidewalls have a narrower thickness than the cooking sidewalls. Each sidewall has a greater thickness at a lower portion, and each sidewall has greater thickness where it is adjacent to a heating element assembly. The grill has opposed sidewalls at each trough, each having a typical thickness, but each trough sidewall is tapered to narrow as it extends upward. The grill has exterior walls defining a perimeter, and the exterior walls are thinner than the typical thickness of the trough sidewalls.

Together, these features retain heat in the center of the appliance, because heat conduction is limited through the thinner material sections. In an exemplary embodiment in accordance with the invention, the thicknesses at the locations shown in FIG. 5a range within the approximated limits shown in Table 1 following:

TABLE 1

| Reference | | |
|---|---|---|
| Numeral in | Minimum Material | Maximum Material |
| FIG. 5a | Thickness, approx. | Thickness, approx. |
| t₁ | 0.409 in | 0.420 in |
| t₂ | .265 | 280 |
| t₃ | .184 | .200 |
| t₄ | 100 | .120 |
| t₅ | .095 | .115 |
| t₆ | 095 | .115 |

All figures in the above table represent inch thicknesses. In preferred embodiments for concentrating the heat close to the cooking areas of the grill, for reducing waste heat, and for maintaining the peripheral surfaces most likely to be touched by users at temperatures lower than the cooking temperature, it is seen that thickness t₁ is greater than t₂, and thickness t₃ is greater than t₄. It is also seen that thickness t₁ is greater than t₃ and thickness t₂ is greater than t₄, so that at the cooking surfaces the inner or medial walls are also thicker than the outer walls. In some preferable embodiments the peripheral walls of the appliance may be even thinner than the thinnest of the uppermost cooking surface thicknesses, as seen in the exemplary dimensions shown in the table. The horizontal surface bridging between the adjacent troughs (see [38] in FIG. 5b) may also be thinner than the upper portions of the sloped surfaces of the troughs such as at thickness t₂.

FIG. 5b shows a cross section view of the electric taco griddle of FIG. 1 taken at section line B-B of FIG. 4. The thick-walled sections of the cooking troughs of the grill casting represent heat sink facilities. Each of the heat sink facilities defines a channel [34] configured to closely receive an elongated portion [33] of the heating element assembly. The lower surface portion of the grill casting has a plurality of heat sink facilities, each registered with one of the troughs, and the heating element assembly is connected to each of the heat sink facilities.

Each trough is defined by spaced-apart cooking sidewalls connected at a lower surface portion and a heating element assembly connected to the lower surface portions. Each trough is defined between an inboard cooking sidewall and an outboard cooking sidewall, with the inboard cooking sidewalls being proximate each other and the inboard cooking sidewalls being thicker than the outboard cooking sidewalls. Other, outer sidewalls are connected to the cooking sidewalls at their upper portions.

In the exemplary embodiment shown, the trough on the left is shown with a loaded taco shell and fillings cooking inside the taco [1.] Heat is delivered evenly from the heat sink facility [42a] through the thicker lower portions of the walls of the cooking trough. The inboard lower wall thickness at [36c] is thicker than the outboard wall thickness [36b] at a comparable level. The upper portions of the cooking sidewalls are thinner than the lower portions, so upper sidewall [36a] is thinner than lower sidewall [36b,] upper sidewall [36d] is thinner than lower sidewall [36c,] upper sidewall [46a] is thinner than lower sidewall [46b,] and upper sidewall [46d] is thinner than lower sidewall [46c.] Outer sidewalls connect at [37] to the cooking troughs. The inboard or medial upper sidewalls of the two adjacent cooking troughs are connected at [38.] The heavy heat sink block transmits heat to each trough. A low thermal gradient in cooking area and a higher high thermal gradient at peripheral surfaces contains the heat in regions where it will be used for cooking, thus using the electricity more efficiently.

In an exemplary cooking operation, a cooking heat of about 375° F. is achieved in a cooking trough, a temperature taken at or near the top of the trough is about 325° F., a temperature taken at or near an outer upper wall is about 250° F., and a temperature taken at or near an outer lower wall is about 225° F. While probably uncomfortable even for short periods of contact, persons accidentally brushing up against the appliance while it is in use are subject to much less injurious temperatures, and the surfaces with the highest temperatures are central to the appliance and substantially recessed from accidental contact. Thus the invention brings increased operational safety to a cooking or a commercial work environment.

FIG. 6a shows an oblique, top rear left view of the grill casting [12] of the electric taco griddle of FIG. 1. The electric taco griddle is a food heating appliance comprising a grill member having an upper food contact surface seen in this figure. The food contact surface has an articulated surface defining a plurality of upwardly-open cooking troughs [13a] and [13b.] The grill is a single casting where in preferable embodiments the grill is a unitary body preferably a seamless body above its lower rim. Peripheral to the inner cooking surfaces, the grill casting includes outer sidewalls whose upper portions are connected to upper portions of the cooking sidewalls. As a casting, the angled surfaces as shown will part easily and neatly from a cope portion of a flask.

FIG. 6b shows an oblique, bottom rear left view of the grill casting [12] of the electric taco griddle of FIG. 1 and its channel features [34] configured to closely receive elongated and serpentine portions of the heating element assembly. As is seen in this underside view, the grill component is a casting free of undercuts and free of negative draft angles. As a casting, the angled surfaces as shown will part easily and neatly from a drag portion of a flask, and it may be feasible to cast such a component in conventional green sand molds with limited or even no need of baked cores or other inserts.

It is also possible to create a food heating appliance in accordance with the invention having more articulated sections defining just one trough or more than two troughs, and for heating both sides of the total number of troughs it will be understood that the number of elevated portions will be greater by one than the number of troughs. In preferable embodiments the troughs have a constant cross section along their lengths, and the entire grill panel also has constant cross-sectional profile. The appliance includes a heating element segment below and aligned with each sidewall.

Many modifications and variations on the present disclosure may be made and other methods performed without departing from its spirit and scope. For example, the appliance may also be used for making flautas without deep frying. To make flautas, a user may partially cook tortillas in the heated troughs of the device, remove them to add meats and other fillings, roll the partially cooked shells to close them over the fillings and then replace the filled tortilla tubes in the heated troughs to cook until crispy. Flautas made using this appliance and method will contain much less oil than traditionally prepared fare and allow calorie conscious people to continue to enjoy these foods.

The special shape of the cooking surfaces may also be amenable to cooking other tube-shaped foods such as Asian egg rolls, spring rolls, or other lenticular foods, and may inspire entirely new food creations. Yet other versions or styles may be created within the scope of the invention, such as additional troughs or different positions or locations of the temperature controller, or combinations of these variations. Thus, although many exemplary embodiments are described above, it will be appreciated that the invention is intended to cover all modifications and equivalents within the scope of the following claims.

I claim:

1. A food heating appliance comprising:
a grill member having an upper food contact surface; the food contact surface having an articulated defining a plurality of upwardly-open cooking troughs each configured to receive a food item;
each trough defined by spaced-apart cooking sidewalls connected at a lower surface portion; and
a heating element assembly connected to the lower surface portions.

2. The food heating appliance of claim 1, wherein the heating element is a horizontal element below the troughs.

3. The food heating appliance of claim 1, wherein the sidewalls are tapered, and narrow upwardly.

4. The food heating appliance of claim 1, including outer sidewalls whose upper portions are connected to upper portions of the cooking sidewalls.

5. The food heating appliance of claim 4, wherein the outer sidewalls have a narrower thickness than the cooking sidewalls.

6. The food heating appliance of claim 1, wherein each trough is defined between an inboard cooking sidewall and an outboard cooking sidewall, the inboard cooking sidewalls being proximate each other, and the inboard cooking sidewalls being thicker than the outboard cooking sidewalls.

7. The food heating appliance of claim 1, wherein the heating element assembly is connected directly to the lower surface portion in physical contact therewith.

8. The food heating appliance of claim 1, wherein the lower surface portion has a plurality of heat sink facilities, each registered with one of the troughs, the heating element assembly connected to each of the heat sink facilities.

9. The food heating appliance of claim 8, wherein each of the heat sink facilities defines a channel configured to closely receive an elongated portion of the heating element assembly.

10. The food heating appliance of claim 1, wherein the grill has a peripheral rim encompassing the heating element assembly.

11. The food heating appliance of claim 10, wherein the lower rim is at a level below the troughs.

12. The food heating appliance of claim 10, including a planar bottom panel attached to the grill to enclose the heating element assembly.

13. The food heating appliance of claim 10, wherein the grill is a unitary seamless body above the lower rim.

14. The food heating appliance of claim 1, wherein the grill is a unitary body.

15. The food heating appliance of claim 1, wherein each sidewall has a greater thickness at a lower portion.

16. The food heating appliance of claim 1, wherein each sidewall has a greater thickness adjacent to the heating element assembly.

17. The food heating appliance of claim 1, wherein each sidewall is tapered to narrow as it extends upward.

18. The food heating appliance of claim 1, including a heating element segment below and aligned with each sidewall.

19. The food heating appliance of claim 1, wherein the grill has opposed sidewalls at each trough, each having a typical thickness, and the grill has exterior walls at a perimeter, and the exterior walls are thinner than the typical thickness of the trough sidewalls.

20. The food heating appliance of claim 1, wherein the grill is a casting free of undercuts and free of negative draft angles.
